(19) United States
(12) Patent Application Publication
(10) Pub. No.: US 2013/0342700 A1
(43) Pub. Date: Dec. 26, 2013

(54) SYSTEM AND METHOD FOR USING PATTERN MATCHING TO DETERMINE THE PRESENCE OF DESIGNATED OBJECTS IN DIGITAL IMAGES

(71) Applicant: Aharon KASS, Herzliya (IL)

(72) Inventor: Aharon KASS, Herzliya (IL)

(21) Appl. No.: 13/532,817

(22) Filed: Jun. 26, 2012

(51) Int. Cl. H04N 7/18; H04N 5/225; G06K 9/62

(52) U.S. Cl. 348/159; 382/209; 348/169; 348/E07.085; 348/E05.024

(57) ABSTRACT

A system and method for determining a presence of a designated object in digital images is provided. Images may be acquired by cameras configured to record events that take place in a region of interest. Processing means may perform pattern matching. The cameras may be controlled by the processing means to track the designated object.

### FIELD OF THE INVENTION

The invention is related to the field of video analytics. Specifically the invention is related to pattern matching to determine the presence of designated objects in digital images. More specifically the invention is related to pattern matching to determine the presence of designated objects in video images.

### BACKGROUND OF THE INVENTION

There are many applications in which it is desired to be able to identify objects that are present, approaching, or passing through a certain area. For example, it might be desired to monitor hospital parking lots to be sure that only authorized vehicles, e.g. those of handicapped persons or staff, enter and park in certain assigned areas. In another example, it might be desired to track the movements of the vehicles of a company or service provider along specified routes or throughout a city to determine the effectiveness of the routes chosen or the correlation between the published schedule, e.g. for a bus route or mail pick-up service, and the actual time of arrival and departure from each station.

Today, in order to provide the desired information in such situations it is usually necessary to send personnel out into the field to make on site observations that are manually compiled to provide the desired report.

Methods of logo detection that are somewhat related to the present invention are currently used in the broadcasting industry. Examples of these methods are:
U.S. Pat. No. 7,356,084 teaches a method for detecting logos, such as station identification logos that are superimposed over the video images at fixed locations on the screen, and for determining when the logo disappears from the broadcast. The method is used to control processing or removing the logo to prevent problems such as screen burn on high definition TV sets.
US2003/0076448 teaches a method of preparing a video summarization of broadcast sporting events. The invention is based on the assumption that the most important or interesting scenes of the game are replayed during the course of the full length live broadcast. Typically the replayed scenes are distinguished from the live play by the use of logos or special visual effects at the beginning and end of each replay scene. These logos are unchanged by the broadcaster at least during the course of a single game and usually are unchanged for an entire season or longer. The invention makes use of various methods of detecting the beginning and end logos to extract the replay sections of the broadcast from which a complete video summary of the sporting event is compiled.
U.S. Pat. No. 7,020,336 teaches a method for detecting the presence of specific logos in television broadcasts. The method is used for example for reporting to advertisers the length of time that their logo can be seen during the broadcast or to enable the director to determine which image from the multiple cameras used to record the event should broadcast to insure that a particular advertiser's logo appears on the screen for the required amount of time. The method is able to compensate for viewing of the logo from different angles and for motion of the camera recording the scene.

The methods of logo detection used in the broadcast industry are characterized in that the position of the logo relative to the scene being recorded and broadcast is fixed. This is in contrast to applications in which the logo is attached to objects which can move independently and therefore whose location changes in consecutive images not only as a result of camera movement but also as a result of the motion of the objects to which they are attached.

It is therefore a purpose of the present invention to provide a system and method of automatically providing desired information concerning the presence and movement of persons, objects, and vehicles by searching for logos attached to them in video images.

Further purposes and advantages of this invention will appear as the description proceeds.

### SUMMARY OF THE INVENTION

In a first aspect the invention is a system for using pattern matching to determine the presence of designated objects in digital images. The system comprises the steps of:
a. one or more cameras that are set up to record events that take place in a region of interest;
b. processing means that comprise dedicated software adapted to carry out the steps of the pattern matching process;
c. input and output means;
d. display means; and
e. communication means between the cameras and the processing means.

The cameras can be selected from film cameras, analog cameras, digital single frame cameras, and digital video cameras.

In embodiments of the invention the dedicated software comprises setup software and detection software.

In embodiments of the invention, processing means and IP (Internet Protocol) based setup software are contained within the body of the camera or within a small box attached to the body of the camera or within a multi channel box comprising multiple input and output connectors.

In embodiments of the invention, IP based detection software is contained within the body of the camera or within a small box attached to the body of the camera or within a multi channel box comprising multiple input and output connectors.

An embodiment of the system of the invention comprises an autonomous PTZ camera that contains software that allows the PTZ camera to determine the presence of a pre-selected logo and automatically track the object to which the logo is attached throughout the PTZ camera's field of view.

Embodiments of the system of the invention comprise a separate camera, which is activated to track designated moving objects. In some of these embodiments, after the presence of a pre-selected logo is determined by the system, the system determines positional information for the object and sends instructions to an autonomous PTZ camera that contains software that allows the PTZ camera to automatically track the object to which the logo is attached throughout the PTZ camera's field of view. In others of these embodiments, after the presence of a pre-selected logo is determined by the system, the system determines positional information for the object to which the logo is attached in each successive frame of a video stream produced the cameras of the system and the software of the system is enabled to instruct the processor of the system to convert the positional information into commands that activate the motors that are responsible for the PTZ motion of a “slave” camera, which tracks the motion of the object as it moves from frame to frame.

In a second aspect the invention is a method for pattern matching to determine the presence of designated objects in digital images. The method comprises the following stages:
a. a pre-processing stage in which the digital signatures of the source patterns are created;
b. an optional user setup stage in which the user may configure the system; and
c. a real time processing stage in which the system tries to match the digital signatures of the source pattern with full or partial frame signatures of the images.

The pre-processing stage is performed off line and comprises the following steps:
a. loading a frontal digital image of the source pattern into the computing means of the system by the user;

followed by the following steps performed by the software of the system:
b. performing transformations of the source pattern;
c. creating a set of unique signatures, one for each of the transformed source patterns;
d. saving the set of signatures in the database of the computer; and
e. creating a collection of sets of transformed signatures and storing them in the database by repeating steps a to d for each source pattern of interest.

The user setup stage is carried out off line, the stage comprising one or more of the following steps carried out by the user:
a. setting the basic depth information for the video images;
b. selecting a source pattern from the collection in the database that should be detected;
c. selecting the area of the video images in which the system is to look for the source pattern;
d. instructing the system whether to detect only the first appearance of the selected source pattern or also multiple appearances of the selected source pattern;
e. instructing the system whether to detect only complete occurrences of the selected source pattern or also partial occurrences of the selected source pattern;
f. instructing the system which of the transformations from the set of transformations of the selected source pattern should be used;
g. instructing the system how to react if the selected source pattern is found in the video images; and
h. repeating steps b to g are for each source pattern of interest to the user.

The processing stage is carried out in real-time on the video images that are input into the processing means, the stage comprising the following steps carried out by the detection software:
a. selecting a single frame from the video;
b. creating a unique signature for the full frame or a partial frame selected by the user;
c. trying to match the source pattern signature to the full or partial frame signature while looking only in the predefined area of the full frame;
d. determining a geometric transformation from the features of the source pattern to those of the full frame and reacting according to definitions supplied by the user, if a match is made;
e. repeating steps a to d for each frame in the video.

In a third aspect the invention is a method for tracking a moving object. The method comprises the steps:
a. identifying a logo attached to the object in a frame of a video stream;
b. determining positional information for the object;
c. creating an instruction comprising the positional information that is used to activate an autonomous PTZ camera that contains software that allows the PTZ camera to locate and automatically track the object throughout the PTZ camera's field of view.

In a fourth aspect the invention is a method for tracking a moving object comprising the steps of:
a. identifying a logo attached to the object in a frame of a video stream;
b. determining positional information for the object;
c. creating an instruction comprising the positional information that is used to activate the motors that are responsible for the PTZ motion of a “slave” camera in order to point the slave camera at the object;
d. repeating steps a to c for each frame of the video stream.

All the above and other characteristics and advantages of the invention will be further understood through the following illustrative and non-limitative description of preferred embodiments thereof, with reference to the appended drawings; wherein like components are designated by the same reference numerals.

### BRIEF DESCRIPTION OF THE DRAWINGS

FIG. 1 symbolically shows the system of the invention;

FIG. 2 is a flow chart outlining the steps of the pre-processing stage of the method of the invention;

FIG. 3 is a flow chart outlining the steps of the user setup stage of the method of the invention; and

FIG. 4 is a flow chart outlining the steps of the processing stage of the method of the invention.

### DETAILED DESCRIPTION OF PREFERRED EMBODIMENTS

The system and method of the present invention are based on the use of pattern matching to identify specific objects in digital images taken by cameras set up to monitor events that take place in the area of interest. The images can be either digitized analog pictures taken with film or analog cameras, images taken with single shot digital cameras, or multiple frame videos. For most of the applications of the invention the images will be video images taken by surveillance cameras. The camera types can range from simple cameras having fixed focal length and field of view to those having advanced PTZ (Pan, Tilt, and Zoom) and tracking ability. The cameras can be mounted such that they always point in given direction or they can be mounted on a mechanism comprising a motor that allows the viewing angle and zoom to be changed on instruction from the user or system, periodically, or continuously.

The nature of the technical problems solved by the invention can be most easily understood in terms of the following descriptions of typical applications in which it can be used.

Application 1: In many cities there are special traffic lanes that are reserved for the exclusive use of buses and taxis. The challenge is to continually monitor these lanes and to identify and bring to justice offenders. The solution supplied by the present invention is to set up one or more video cameras to monitor the flow of traffic in the designated lanes. In most cases such cameras are already in place and continuously transmit images to a remote traffic control center. Each bus or taxi will have one or more logos or other identifying signs on it. This can be a standardized logo issued by the authorities to all authorized users of the special lane, can be the company logos of the bus and taxi companies that operate in the area, or can simply be a word such as taxi, bus, or autobus painted somewhere on the side or roof of the vehicle. In either the individual cameras or in the computers at the centralized control station is installed dedicated software, which will be described herein below. The software contains a data base of signatures of all the logos that are expected to appear on the vehicles authorized to travel in the lane. It also contains algorithms creating full frame signatures for all objects in each frame received from the camera and for attempting to match the signatures from the data base with those in the frame. If one or more of the defined logos are found, then no action is taken by the system. If none of the logos is found on the vehicle/s in the frame, then the system can automatically take a number of actions depending on the choice of the operator. For example, the camera can be instructed to zoom in on the license plate of the offending vehicle, a second camera can be instructed to take a snapshot of the vehicle and its license plate, or a real time alert that an unauthorized vehicle is approaching can be transmitted to a policeman waiting further up the road.

Application 2: At construction sites it is often important to keep track of the movement of workers and visitors on the site. At different stages of the project, for safety or other reasons, different groups of workers are allowed access to certain areas and workers with different skills are denied access. Some areas are off-limits to visitors and others are not. Instead of relying on all persons to follow the rules or assigning security personnel to either man checkpoints, continuously monitor images from surveillance cameras, or patrol the site, the system of the invention can easily provide a much more effective and less expensive solution. Since all persons at a construction site are required to wear a hard hat, decals containing distinctive symbols or logos for each group or class of person on the site can be affixed to their hard hat. Security cameras in each area of the site will transmit images to a central location and the software of the invention will match the known signatures to those in the images to verify that only authorized persons are in each area. The system can also improve safety on the site, since if a person is not wearing a helmet, one of the authorized logos will not be recognized in the images and the system can send an appropriate warning.

Application 3: Using existing cameras set up at intersections and along highways and roads, the movement of delivery trucks from a specific firm or organization can be tracked over a wide area.

Application 4: The system of the invention can be configured to recognize hazmat signs on trucks and give a warning when vehicles transporting hazardous materials enter city streets or approach tunnels or bridges. Such information can be used by traffic controllers, for example, to slow the flow of traffic or even stop it from entering a tunnel until the truck carrying the hazardous material has exited.

Application 5: In warehouses, ports, airports, etc., the system of the invention can be used to identify and track movement of designated shipments or search for missing containers, cartons, or crates by recognizing characteristic logos or markings on them.

Application 6: In stores and shopping malls the system can be used to collect statistics, such as the number of persons who are wearing shirts with the logo of a particular designer.

Application 7: Using the present invention, a child lost in a shopping mall can be quickly located. In this case the parent identifies the child in the recorded images from the camera at the entrance that they used to enter the mall. Then using the GUI of the system of the invention the security guard can instruct the software of the system to automatically locate and create a signature for a distinctive feature that can be used to locate the child. Such a feature could be a logo on the shirt or hat worn by the child or a symbol on the book bag carried by him. Alternatively, the logo can be supplied to the software of the system from another source, e.g. downloaded from the internet. The software of the system then searches through the images streaming in from all cameras in the mall, creates a signature for the distinctive features in each image and attempts to find a match for the signature associated with the missing child.

It is not the intention of the inventor that the invention be limited to the specific examples described hereinabove or to any other of the many more potential uses of the invention that could be described.

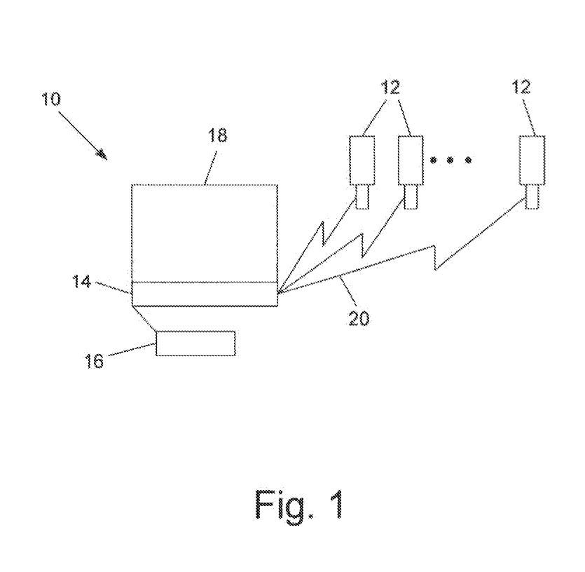

The system of the invention 10 is symbolic shown in FIG. 1. It comprises one or more digital cameras 12 that are set up to record events that take place in a region of interest, processing means 14 that comprise dedicated software adapted to carry out the steps of the pattern matching process, input and out put means 16, display means 18, and communication means 12 between the cameras and the processing means. The method of the invention can be carried out by running the software on embodiments of the processing of the means 14 that can be located either inside the camera or in a small box attached to the camera or at a central location in a dedicated unit having multiple input and output connectors.

The characteristics of the components of the system depend to a certain extent on the nature of the application. For example, the method can be used to allow access to a building or room only to authorized persons by means of a single camera set up at the entrance to the building, digitally photographing each individual that approaches the entrance and processing the images to determine if a special logo appears on the identification tag worn by the individual. In this case, by proper design of the approach to the entrance, the area of interest can be limited to the upper body of one person at a time; therefore, a camera that shoots one frame at a time can be used.

The processing means can be integrated with the electronics of the camera and located, together with the software necessary to carryout the method of the invention, within the case of the camera or in a small box attached to the camera case. The logo or logos that allow access to the building are preloaded into the software on the camera and the output of the process carried out by the software is simple, i.e. if the logo appears on the tag then a signal is sent from the camera to open an electronic lock or to signal a guard by lighting a green light. If the logo is not found in the image, then access is denied.

At the other extreme, if the application is to track the movement of all Post Office vehicles throughout all the streets of a large city 24 hours a day seven days a week, then a large number of video cameras providing a continuous stream of images from the area of interest are needed in order to obtain optimal results. For this application, the existing system of video cameras that are installed at intersections to monitor traffic can be employed. The detection software of the system can be installed in a box attached to the individual cameras, which are normally analog cameras. In this case a simple low band width system can be used to transfer the images to be displayed in the central control room. Alternatively the detection software can be installed in the existing computers or a dedicated computer or computers which are provided in the central control room. In this case, the cameras send real time high quality video images to computers in a central control room. Communication between the cameras and the control station can be, for example by means of conventional or optical cable or by use of wireless technology.

The method of the invention comprises three stages:
a. a pre-processing stage in which the digital signature of the source pattern are created;
b. an optional user setup stage in which the user may configure the system; and
c. a real time processing stage in which the system tries to match the digital signature of the source pattern with full or partial frame signatures of the images.

The setup software is located in the camera itself, in a dedicated box attached to the camera, or in a central multi-channel box and is IP (Internet Protocol) based. This means that the setup can be done from any place in the world using any internet browser and conventional input and output means such as a keyboard and computer mouse. Preferably a dedicated Graphical User Interface (GUI) that guides the user through the process of using the method of the invention and helps him to configure the system for his specific application is used, but this is not a necessity. In embodiments of the invention the GUI is displayed on a touch screen that simplifies the input of instructions to the system. After the setup has been performed using the browser the unit, i.e. the camera, dedicated box, or multi-channel box, is a completely self sustained device. The user can decide what type of output to use to utilize the events generated by the unit, e.g. to view them on a PC, an analog monitor, or cell phone screen, or to receive an audible signal confirming the occurrence of a predetermined event.

The detection software need not run on the same processor as the setup software. The processor running the detection software can be located in the camera, in the dedicated box attached to the camera, or in a central location

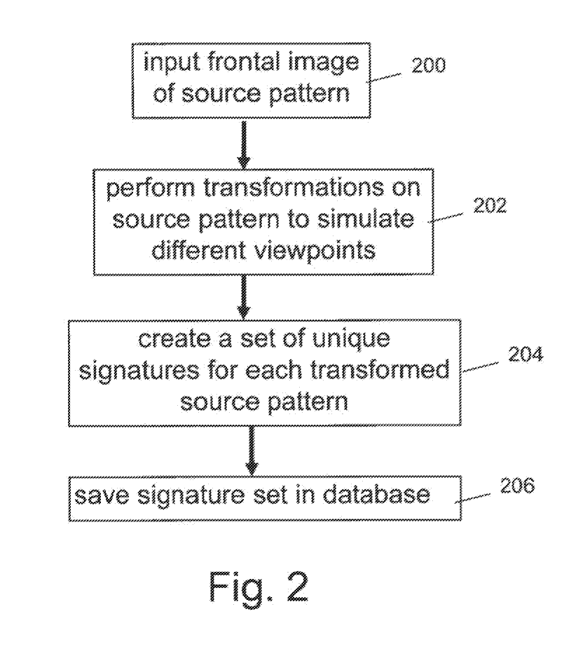

FIG. 2 is a flow chart outlining the steps of the pre-processing stage. This stage is performed off line using the GUI of the system. In the first step 200 a frontal digital image of the source pattern, for example a company logo, is loaded into the computing means of the system. The software of the system then performs transformations (step 202) on the source pattern to simulate different viewpoints, different lighting conditions, etc. Next (step 204) a set of unique signatures, one for each of the transformed source patterns, is created. Finally (step 206) the set of signatures is saved in the database of the computer. This process is repeated for each source pattern of interest. The end result of the pre-processing stage is a collection of sets of transformed signatures, which comprises one set of signatures for the transformed source pattern for each of the source patterns of interest.

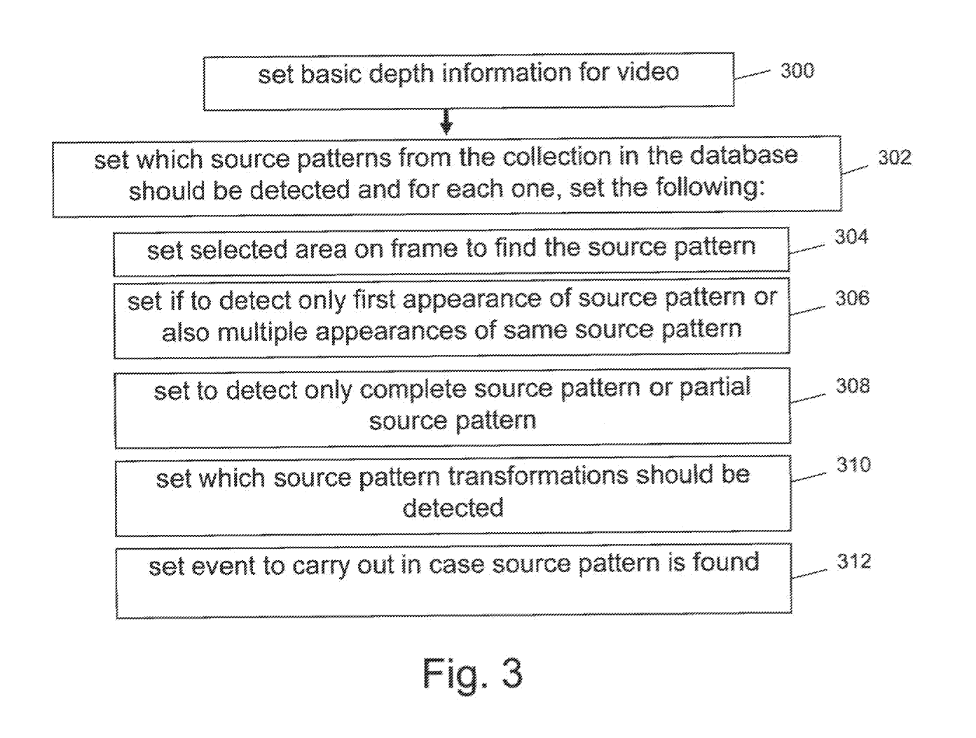

FIG. 3 is a flow chart outlining the steps of the user setup stage of the method of the invention. This stage is also carried out off line using the GUI of the system. All of steps in this stage are optional. Providing the information makes the system run faster and more accurately; however, the detection software responsible for carrying out the real time processing stage can function with or without input from the user. In the first step 300, the user sets the basic depth information for the video images. Depth setup means calculating the distance of each pixel from the camera, i.e. creating a pseudo three dimensional representation of the field of view. The necessary information can be supplied by the user in many forms. The user can specify e.g. the height of a person at various locations in the field of view or the distance between pixel locations on the display screen. In the next step 302 the user tells the system which source patterns from the collection in the database should be detected. For each of the source patterns the user must set the following information:
a. step 304—The area of the video images (frame) in which the system is to look for the source pattern is selected. For example, the application is to confirm that only buses or taxis are traveling in the right hand commuter lane of a four lane highway. The video camera has a wide field of view that images all four lanes. Therefore the system will be told to only look for the logos of buses and taxis in quarter of the image that shows the right hand lane.
b. step 306—The source pattern may appear several times in the same frame. In this step the user tells the system whether he wants to get an event only for the first instance that the source pattern is detected or if he wants a separate event each time the source pattern is detected in the frame.
c. step 308—In this step the user can also choose whether the system should report a positive identification only if the whole source pattern is found or if it should also report a partial finding.
d. step 310—The user tells the system which of the transformations from the set of transformations should be used. For example, if the camera is positioned six meters above the road bed, then there is no point in investing the system's resources looking for signatures of the transformations that corresponds to a straight-on or an upward-looking view. In another example, only vehicles or persons approaching the camera position are of interest, therefore only frontal signature of the source pattern need be detected. The use of these transformations adds a directional layer relating the position of the camera to the direction of motion of the object bearing the source pattern.
e. step 310—If the source pattern is found in the video images, than the system must be told how to react. The reaction of the system can take many forms depending on the requirements of the application. The system can activate a relay output or issue a command through a defined protocol to other systems will receive the command and react accordingly. Typical reactions can be: to allow or deny access building, to display a visual or aural alarm, to increase a counter, to output a time code to a database, or activate a camera to monitor and record or to track or zoom in on the object that bears the source pattern.

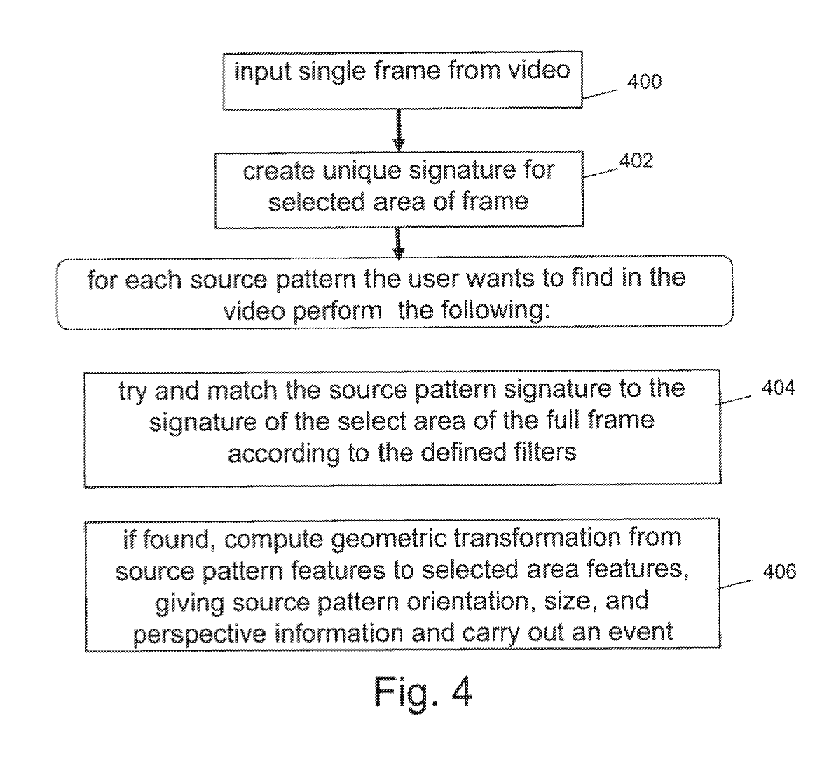

FIG. 4 is a flow chart outlining the steps of the processing stage of the method of the invention. This stage is carried out in real-time on the video images that are input into it. The system of the invention can support real-time video as it is being shot and also pre-recorded video from any recording device, e.g. a DVR logger. Whatever the source, a single frame from the video is selected by the software (step 400). The system than creates a unique signature for the area of the full frame that was selected in step 304 (step 402). Now for each source pattern that the user wants to find the following steps are performed:
a. step 404—The system looks only in the predefined area of the full frame (see, step 304) and tries to match the source pattern signature to the signature of the selected area. The matching is done according to the parameters set in the user set-up stage, e.g. which of the transformations is supported, single/multiple source pattern search, maximum/minimum size.
b. step 406—If a match is made the system computes a geometric transformation from the source pattern features to those of the selected area of the full frame. The transformation gives information relating to the orientation of the source pattern, its size, and perspective in the frame. If a match is found, then the system also carries out the event defined by the user in step 312.
   Steps 400 to 406 are repeated for each frame in the video. Until instructed to do so by the user the application never stops since it needs to continuously process the images of the region of interest sent by the cameras and generate an event according to the definitions supplied by the user in the user setup stage. If no area (or areas) of the full frame is selected by the user in step 304, then in step 402 the system creates a signature, which is used in step 404, for the entire frame. In step 406 the transformation is from the source pattern features to those of the full frame.

An extremely useful feature of the present invention is that the system of the invention can be used to activate a separate camera to track moving objects. This feature can operate in two modes.

In the first mode, after the pre-selected logo is identified by the system in step 406, the system calculates positional information for the object and an instruction comprising the positional information is sent to activate an autonomous PTZ camera that contains software that allows it to automatically track the object to which the logo is attached throughout the camera's field of view. Note that this mode can be used with only one autonomous PZT camera, which comprises the software of the system that enables it to recognize the logo. After the logo is recognized then the camera automatically tracks the motion of the object to which the logo is attached as long as the object remains in the field of view.

In the second mode, after the presence of a pre-selected logo is determined by the system, the system calculates positional information for the object to which the logo is attached in each successive frame of a video stream produced the cameras of the system. The software of the system is enabled to instruct the processor of the system to convert the positional information into commands that activate the motors that are responsible for the PTZ motion of a “slave” camera, which tracks the motion of the object as it moves from frame to frame. In this way the slave camera receives instructions to track the motion of the object in a step-wise fashion as it moves from frame to frame.

Although embodiments and applications of the invention have been described by way of illustration, it will be understood that the invention may be carried out with many variations, modifications, and adaptations, without exceeding the scope of the claims.

1. A system for using pattern matching to determine the presence of designated objects in digital images, the system comprising:
one or more cameras set up to record events that take place in a region of interest; and
a processor in communication with said one or more cameras to perform a pattern matching process;
wherein the processor is to determine, based on the pattern matching process, a presence of at least one designated object and, upon determining a presence of the at least one designated object, select an action to be performed.

2. The system according to claim 1, wherein the cameras are selected from the following group:
a. film cameras;
b. analog cameras;
c. digital single frame cameras; and
d. digital video cameras.

3. The system according to claim 1, wherein the processor is to perform a setup process and a detection process.

4. The system according to claim 3, wherein the processor and an Internet Protocol (IP) based setup software are contained within a camera.

5. The system according to claim 4, comprising IP based detection software.

6. The system according to claim 3, wherein processor and IP based setup software are contained within a small box attached to the body of the camera.

7. The system according to claim 6, comprising IP based detection software.

8. The system according to claim 3, wherein the processor and an IP based setup software are contained within a multi channel box comprising multiple input and output connectors.

9. The system according to claim 8, comprising IP based detection software.

10. The system according to claim 1 comprising an autonomous pan-tilt-zoom (PTZ) camera that contains software that allows said PTZ camera to determine the presence of a pre-selected logo and automatically track the object to which said logo is attached throughout said PTZ camera's field of view.

11. The system according to claim 1 comprising a separate camera, which is activated to track designated moving objects.

12. The system according to claim 10 wherein, after the presence of a pre-selected logo is determined by said system, said system determines positional information for said object and sends instructions to an autonomous PTZ camera that contains software that allows said PTZ camera to automatically track the object to which said logo is attached throughout said PTZ camera's field of view.

13. The system according to claim 10 wherein, after the presence of a pre-selected logo is determined by said system, said system determines positional information for the object to which said logo is attached in each successive frame of a video stream produced the cameras of said system and the software of said system is enabled to instruct the processor of the system to convert said positional information into commands that activate the motors that are responsible for the PTZ motion of a “slave” camera, which tracks the motion of said object as it moves from frame to frame.

14. A method for using pattern matching to determine a presence of designated objects in digital images, said method comprising:
a pre-processing stage including generating digital signatures of source patterns; and
matching a digital signature of a source pattern with a signature of a digital image to determine a presence of a designated object in the digital image.

15. The method according to claim 14, wherein the pre-processing stage is performed off line, said stage comprising:
a. loading, by a user, a frontal digital image of the source patterns;
b. performing transformations of said source patterns;
c. creating a set of unique signatures, one for each of the transformed source patterns;
d. saving said set of signatures in a database; and
e. creating a collection of sets of transformed signatures and storing said collection in said database by repeating steps a to d for each source pattern of interest.

16. The method according to claim 14, including a setup stage performed offline, said stage comprising one or more of the following steps:
a. setting the basic depth information for the video images;
b. receiving a selection of a source pattern from the collection in the database that should be detected;
c. receiving a selection of an area of the video images in which the system is to look for the source pattern;
d. receiving an instruction of whether to detect only the first appearance of said selected source pattern or multiple appearances of said selected source pattern;
e. receiving an instruction to detect only complete occurrences of said selected source pattern or also partial occurrences of said selected source pattern;
f. receiving an indication of the transformations from the set of transformations of the selected source pattern to be used;
g. receiving an instruction how to react if said selected source pattern is found in said video images; and
h. repeating steps b to g for each source pattern of interest to said user.

17. The method according to claim 14, wherein matching a digital signature of a source pattern with a signature of a digital image is carried out in real-time on video images that are input into the processor, said stage comprising:
a. selecting a single frame from the video;
b. creating a unique signature for said full frame or a partial frame selected by the user;
c. trying to match the source pattern signature to said full or partial frame signature while looking only in the predefined area of said full frame;
d. determining a geometric transformation from the features of said source pattern to those of said full frame and reacting according to definitions supplied by the user if a match is made;
e. repeating steps a to d for each frame in the video.

18. A method for tracking a moving object, said method comprising:
a. identifying a logo attached to said object in a frame of a video stream;
b. determining positional information for said object;
c. creating an instruction comprising said positional information that is used to activate an autonomous pan-tilt-zoom (PTZ) camera that contains software that allows said PTZ camera to locate and automatically track said object throughout said PTZ camera's field of view.

19. The method of claim 18, wherein the PTZ camera is a slave camera and wherein steps b and c are repeated for a plurality of frames included in the video stream.
